(19) United States
(12) Patent Application Publication
(10) Pub. No.: US 2025/0224083 A1
(43) Pub. Date: Jul. 10, 2025

(54) SHUT-OFF VALVE AND TANK SYSTEM WITH A SHUT-OFF VALVE

(71) Applicant: Robert Bosch GmbH, Stuttgart (DE)

(72) Inventors: Andreas Rau, Stuttgart (DE); Udo Schaich, Stuttgart (DE)

(21) Appl. No.: 18/853,535

(22) PCT Filed: Mar. 10, 2023
(86) PCT No.: PCT/EP2023/056117

§ 371 Date: Oct. 2, 2024

(30) Foreign Application Priority Data
Apr. 13, 2022 (DE) 10 2022 203 734.0

(51) Int. Cl. F17C 13/04; F16K 31/06

(52) U.S. Cl. CPC F17C 13/04; F16K 31/0655; F17C 2205/0326; F17C 2205/0382; F17C 2221/012; F17C 2260/036

(57) ABSTRACT

The invention presented relates to a shut-off valve (100) for closing a tank (201). The shut-off valve (100) comprises a control chamber (101), a pilot-control valve (103), a main valve (105), an electromagnet (107), a driver (109), and a base plate (111), wherein the electromagnet (107) comprises a magnet armature (115) and a coil (113), wherein the pilot-control valve (103) is supported movably in the magnet armature (115), wherein the magnet armature (115) is arranged movably such that, when the coil (113) is electrically energized, the magnet armature (115) moves through a magnet armature stroke (119) in the direction of the base plate (111), wherein the driver (109) is configured to move the pilot-control valve (103) out of a basic position of the pilot-control valve (103), and through a pilot-control valve stroke (121) also in the direction of the base plate (111), into a pilot-control position during a movement of the magnet armature (115), wherein the main valve (105) is movable through a main valve stroke (135) in the direction of the base plate (111), wherein the main valve (105) is configured to move the pilot-control valve (103) out of the pilot-control position, and further in the direction of the base plate (111), during a movement through the main valve stroke (135).

### BACKGROUND

The invention presented relates to a shut-off valve and a tank system having a shut-off valve.

Mobile hydrogen tank systems for use in motor vehicles, for example, include tank valves for filling fuel, such as hydrogen to provide drives, such as fuel cells or hydrogen combustion engines, with fuel. In the event of a line breakage or accident, the hydrogen tanks must be closed independently by means of a shut-off valve, i.e., a check valve, in order to prevent uncontrolled fuel leakage.

### SUMMARY

In the context of the invention presented, a shut-off valve and a tank system are presented. In this context, features and details described in connection with the shut-off valve according to the invention clearly also apply in connection with the tank system according to the invention, and respectively vice versa so that, with respect to the disclosure, mutual reference to the individual aspects of the invention is or can always be made.

The invention presented serves in particular to provide a compact shut-off valve that can in particular be arranged in a cylinder neck of a pressure tank.

Therefore, presented according to a first aspect of the invention is a shut-off valve for closing a tank. The shut-off valve includes a control chamber, a pilot-control valve, a main valve, an electromagnet, a driver, and a base plate.

The electromagnet comprises a magnet armature and a coil, wherein the magnet armature is arranged movably such that, when the coil is electrically energized, the magnet armature moves through a magnet armature stroke in the direction of the base plate.

The pilot-control valve is supported movably in the magnet armature.

The driver is configured to move the pilot-control valve out of a basic position of the pilot-control valve, and through a pilot-control valve stroke also in the direction of the base plate, into a pilot-control position during a movement of the magnet armature.

The main valve can be moved through a main valve stroke in the direction of the base plate and is configured to move the pilot-control valve out of the pilot-control valve position, and further in the direction of the base plate, during a movement through the main valve stroke.

In the context of the invention presented, a driver is to be understood as a component that is movable and configured to contact a movement partner, such as the pilot-control valve provided according to the invention, during a movement and to carry it along at least in some regions during its movement. In particular, the driver according to the invention is a protuberance of the magnet armature according to the invention that is configured to engage a protuberance of the pilot-control valve provided according to the invention.

The shut-off valve presented is based on a very small pilot-control valve stroke of the pilot-control valve generated by a movement of the magnet armature and a larger main valve stroke of the main valve generated by a pressure difference between the control chamber and a high-pressure connection of the shut-off valve.

Since the electromagnet provided according to the invention is only required for a movement of the magnet armature through a small pilot-control valve stroke, the magnet armature may be smaller than known shut-off valves for which a larger pilot-control valve stroke is provided. Accordingly, the proposed shut-off valve may itself be designed very small and placed in a cylinder neck position of a pressure cylinder of a tank.

It may be provided that the pilot-control valve stroke is smaller than the main valve stroke.

A pilot-control valve stroke that is smaller than the main valve stroke minimizes a force required for the pilot-control valve stroke. Accordingly, the electromagnet may be particularly weak and correspondingly small.

It may further be provided that the armature stroke is the same as the pilot-control valve stroke.

As a movement of the magnet armature is transferred to the pilot-control valve by the driver, the magnet armature stroke may be directly converted into a movement of the pilot-control valve and a corresponding pilot-control valve stroke, such that the pilot-control valve and the magnet armature move simultaneously and for the same length or over the same length in the direction of the base plate.

It may be further provided that the pilot-control valve seals a connection of the control chamber extending through the main valve to a low-pressure connection of the shut-off valve in the rest position and releases the connection in the pilot position, such that the low-pressure connection can be filled in the pilot position in order to lower a pressure in the control chamber and to move the main valve through the main valve stroke in the direction of the base plate.

The pilot-control valve is substantially supported movably between a rest position in which the pilot-control valve seals a connection of the control chamber extending through the main valve to a low-pressure connection of the shut-off valve, a pilot position, and further a deflected position in which the connection is released. Accordingly, a movement or pilot-control valve stroke of the pilot-control valve causes fluid to escape from the control chamber via the connection and, as a result, the main valve stroke of the main valve is triggered. Accordingly, the main valve stroke of the main valve is performed without current or without assistance by the electromagnet, but is only driven by a pressure differential between a high-pressure connection or a pressure in a tank coupled to the shut-off valve and the pressure in the control chamber, which varies depending on the position of the pilot-control valve.

It may further be provided that the shut-off valve comprises a sealing element that prevents an inflow to the control chamber from a high-pressure system coupled to the shut-off valve when the main valve has moved through the main valve stroke in the direction of the base plate.

In order to prevent pressure equalization between a high-pressure connection of the shut-off valve and the control chamber and a resulting blockage of a movement of the main valve, a sealing element, such as a foam or a sealing ring, may be provided at an inlet point of the high-pressure connection such that, for example, the main valve pushes the sealing element onto the inlet point when the main valve stroke has moved through the main valve stroke in the direction of the base plate.

It may further be provided that a residual air gap disc is arranged between the magnet armature and the base plate.

A residual air gap disc between the magnet armature and the base plate prevents magnetic adhesion of the magnet armature to the base plate on the one hand and filling of the control chamber through a gap between the magnet armature and the base plate on the other.

It may further be provided that the shut-off valve comprises a pilot-control valve spring that pushes the pilot-control valve out of the pilot-control valve position into the rest position, the shut-off valve comprises a position spring that pushes the main valve to a low-pressure connection of the shut-off valve, and the shut-off valve comprises a main valve spring that pushes the main valve in the direction of the pilot-control valve.

The respective springs, i.e., mechanical spring elements of the shut-off valve, can be used to precisely adjust forces and counterforces, in particular a force to be provided by the magnet armature for the pilot-control valve stroke.

According to a second aspect, the invention presented relates to a tank system for storing a fluid. The tank system comprises a tank and a possible configuration of the shut-off valve presented.

It may be provided that the tank system presented is configured for storing hydrogen.

The shut-off valve presented is particularly suitable for preventing hydrogen from leaking out of a tank, such that the tank system presented is suitable as a particularly safe tank system for storing hydrogen.

It may further be provided that the shut-off valve is arranged in a cylinder neck of a pressure vessel of the tank.

Further advantages, features, and details of the invention arise from the following description, in which exemplary embodiments of the invention are described in detail with reference to the drawings. In this context, the features mentioned in the claims and in the description can each be essential to the invention individually or in any combination.

### BRIEF DESCRIPTION OF THE DRAWINGS

Shown are:

FIG. 1 a schematic representation of a possible configuration of the shut-off valve presented,

FIG. 2 a schematic representation of a possible configuration of the tank system presented.

### DETAILED DESCRIPTION

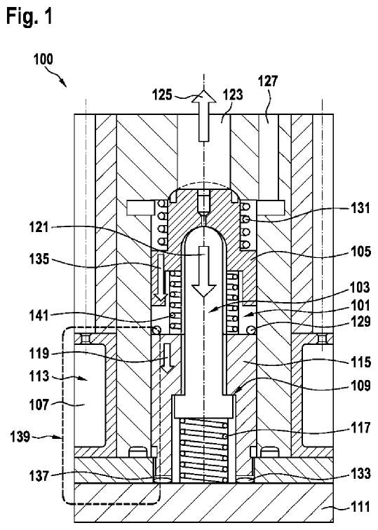

In FIG. 1, a shut-off valve 100 is shown. The shut-off valve comprises a control chamber 101, a pilot-control valve 103, a main valve 105, an electromagnet 107, a driver 109, and a base plate 111.

For example, the base plate 111 may be a part of a housing in which the shut-off valve is installed. Therefore, the base plate 111 may be connected to the shut-off valve 100 via an interface of the shut-off valve 100, in particular a thread, such that the housing or the base plate 111 provides a magnetic flux or return of the magnet armature 107.

Opening forces and holding forces of the pilot-control valve 103 are achieved by controlling or energizing a coil 113. If the coil 113 is electrically controlled, a magnetic field 139 is formed that moves a magnet armature 115 of the magnet armature 107 against a pilot-control valve spring 117 through a magnet armature stroke, as indicated by arrow 119, downwards in the direction of the base plate.

The mechanical driver 109 moves the pilot-control valve 103 through a magnet armature stroke, as indicated by arrow 121, in the same way as the magnet armature movement. The pilot-control valve 103 lifts out of its sealing seat on the main valve 105 and fills a low-pressure connection 123, as indicated by arrow 125, with fluid from the control chamber 101.

The same pressure is applied in the control chamber 101 as in a high-pressure connection 127 or a tank coupled to the high-pressure connection 127 until the pilot-control valve 103 is released from the main valve 105. This is because the control chamber is filled from the high-pressure connection 127 via guide gaps.

Filling and the associated pressure build-up in the low-pressure connection 123 change the pressure conditions at the main valve 105 such that a pressurized surface in the control chamber 101 at the main valve 105 receives a lower pressure and the pressure is raised up to a sealing element 129. Together with the pressurized surface from the high-pressure connection 127, this results in the opening forces on the main valve 105, which are additionally supported by a main valve spring 131, but act against the force of a very small position spring 141.

The main valve 105 moves through a main valve stroke, as indicated by arrow 135, in the direction of the pilot-control valve 103 until it comes into contact with it.

If the main valve 105 continues to move in the direction of the base plate 111, the pilot-control valve 103 is lifted out of the mechanical driver 109 and continues to follow a path of the main valve 105.

By design, the main valve 105 moves until it abuts the sealing element 133 of the magnet armature 115 and is limited in its main valve stroke, as indicated by arrow 135.

The sealing element 133 is arranged such that refilling of the control chamber 101 from the high-pressure connection 127 is prevented or excluded during prolonged actuation or when the main valve 105 is open.

In addition, there is a residual air gap disc 137 between the magnet armature 115 and the base plate 111, for example in the form of a sealing element, which prevents magnetic adhesion of the magnet armature 115 to the base plate 111 and filling of the control chamber 101.

If the electrical actuation of the coil 113 is terminated or interrupted by another event, the magnetic holding force drops and the magnet armature 115 moves away from the sealing element 133, so that fluid flows into the control chamber 101 via the sealing element 133 or corresponding flank surfaces, and, together with the pilot-control valve spring 117, a closing force is applied to the main valve 105 via the pilot valve 103 and the low-pressure connection 123 is closed.

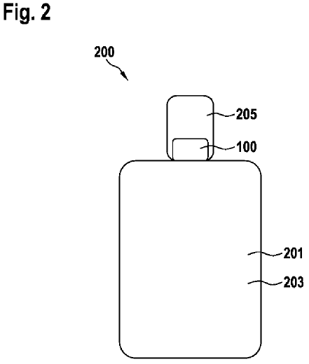

FIG. 2 shows a tank system 200. The tank system 200 comprises a tank 201 having a pressure vessel 203 in the form of a pressure cylinder having a cylinder neck 205.

The stop valve 100 is arranged in the cylinder neck 205.

1. A shut-off valve (100) for closing a tank (201),
the shut-off valve (100) comprising:
a control chamber (101),
a pilot-control valve (103),
a main valve (105),
an electromagnet (107),
a driver (109),
a base plate (111),
wherein the electromagnet (107) comprises a magnet armature (115) and a coil (113),
wherein the pilot-control valve (103) is supported movably in the magnet armature (115),
wherein the magnet armature (115) is arranged movably such that, when the coil (113) is electrically energized, the magnet armature (115) moves through a magnet armature stroke (119) in a direction of the base plate (111), wherein the driver (109) is configured to move the pilot-control valve (103) out of a rest position of the pilot-control valve (103), and through a pilot-control valve stroke (121) also in the direction of the base plate (111), into a pilot-control valve position during a movement of the magnet armature (115),
wherein the main valve (105) is movable through a main valve stroke (135) in the direction of the base plate (111),
wherein the main valve (105) is configured to move the pilot-control valve (103) out of the pilot-control valve position, and further in the direction of the base plate (111), during a movement through the main valve stroke (135).

2. The shut-off valve (100) according to claim 1,
wherein
the pilot-control valve stroke (121) is smaller than the main valve stroke (135).

3. The shut-off valve (100) according to claim 1,
wherein
the magnet armature stroke (119) is a same size as the pilot-control valve stroke (121).

4. The shut-off valve (100) according to claim 1,
wherein
the pilot-control valve (103) seals a connection of the control chamber (101) extending through the main valve (105) to a low-pressure connection (123) of the shut-off valve (100) in the rest position and releases the connection in the pilot-control valve position, such that the low-pressure connection (123) can be filled in the pilot-control valve position in order to lower a pressure in the control chamber (101) and to move the main valve (105) through the main valve stroke (135) in the direction of the base plate (111).

5. The shut-off valve (100) according to claim 1,
wherein
the shut-off valve (100) comprises a sealing element (133) that prevents an inflow to the control chamber (101) from a high-pressure system coupled to the shut-off valve (100) when the main valve (105) has moved through the main valve stroke (135) in the direction of the base plate (111).

6. The shut-off valve (100) according to claim 1,
wherein
a residual air gap disc (137) is arranged between the magnet armature (115) and the base plate (111).

7. The shut-off valve (100) according to claim 1,
wherein
the shut-off valve (100) comprises a pilot-control valve spring (139) that pushes the pilot-control valve (103) to the rest position,
the shut-off valve (100) comprises a position spring (141) that pushes the main valve (105) to a low-pressure connection (123) of the shut-off valve (100), and the shut-off valve (100) comprises a main valve spring (131) that pushes the main valve (105) in a direction of the pilot-control valve (103).

8. A tank system (200) for storing a fluid,
wherein the tank system (200) comprises:
a tank (201), and
a shut-off valve (100) according to claim 1.

9. The tank system (200) according to claim 8,
wherein the tank system (200) is configured to store hydrogen.

10. The tank system (200) according to claim 8,
wherein
the shut-off valve (100) is arranged in a cylinder neck (205) of a pressure vessel (203) of the tank (201).

11. The shut-off valve (100) according to claim 2, wherein the magnet armature stroke (119) is a same size as the pilot-control valve stroke (121).
